(19) United States
(12) Patent Application Publication
(10) Pub. No.: US 2020/0148209 A1
(43) Pub. Date: May 14, 2020

(54) METHOD AND APPARATUS FOR TEMPORARILY DEACTIVATING A FUNCTION FOR MAINTAINING A CONSTANT SPEED FOR A TWO-WHEELED MOTOR VEHICLE, INDEPENDENTLY OF A DRIVER

(71) Applicant: Robert Bosch GmbH, Stuttgart (DE)

(72) Inventors: Mathieu Grelaud, Ludwigsburg (DE); Michael Schoenherr, Renningen-Malmsheim (DE)

(21) Appl. No.: 16/655,815

(22) Filed: Oct. 17, 2019

(30) Foreign Application Priority Data
Nov. 8, 2018 (DE) 102018219027.5

(51) Int. Cl. B60W 30/18

(52) U.S. Cl. CPC B60W 30/18145; B60W 2720/10; B60W 2300/36; B60W 2550/146; B60W 2520/125; B60W 2510/18

(57) ABSTRACT

A method and an apparatus for temporarily deactivating a function of maintaining constant speed for a two-wheeled motor vehicle, independently of a driver, where a speed to be maintained is specified by the driver, the occurrence of cornering is detected, and, in response to the occurrence of cornering, the specified speed is reduced independently of the driver.

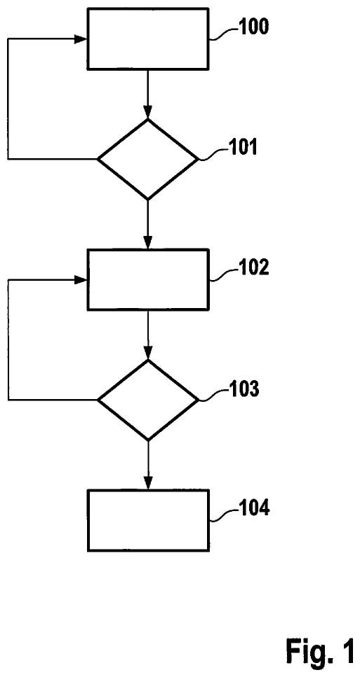

### RELATED APPLICATION INFORMATION

The present application claims priority to and the benefit of German patent application no. 10 2018 219 027.5, which was filed in Germany on Nov. 8, 2018, the disclosure of which is incorporated herein by reference.

### FIELD OF THE INVENTION

The present invention relates to a method and apparatus for temporarily deactivating a function for maintaining a constant speed for a two-wheeled motor vehicle, independently of a driver.

### BACKGROUND INFORMATION

Patent document EP 2 241 498 B1 discusses a speed control device for a motorcycle, which allows the motorcycle to be kept automatically at a preset speed. Such speed control devices are also known as cruise controls.

Today, it is believed that a number of motorcycles may be equipped with an anti-lock braking system suitable for cornering. It includes a sensor system, which ascertains the accelerations in all three spatial directions, as well as the rates of rotation about all three spatial directions. The occurrence of cornering may be detected with the aid of these variables. With regard to the operating dynamics variables, motorcycle drivers have a comfort range, within which they feel happy and secure. This comfort range is not fixed, but is a strong function of the experience and the personality of the driver. This comfort range extends to the question of how rapidly a motorcyclist travels through a curve, and how hard he/she brakes during cornering and subsequently accelerates again.

### SUMMARY OF THE INVENTION

The present invention relates to a method for temporarily deactivating a function for maintaining a constant speed, that is, a cruise control function, for a two-wheeled motor vehicle, independently of a driver, where a speed to be maintained is specified by the driver, the occurrence of cornering is detected, and, in response to the occurrence of cornering, the specified speed is reduced independently of the driver. The two-wheeled motor vehicle may be, in particular, a motorcycle. The present invention prevents a speed set by the driver within the scope of the cruise control function from continuing to be used in the event of cornering, even though the speed is too high for the curve at hand.

One advantageous refinement of the present invention is characterized in that cornering is detected with the aid of a GPS sensor system or with the aid of the sensor system of an anti-lock braking system or ABS system. In interaction with a digital map, the GPS sensor system may ascertain the presence of a curve. The presence of a curve may equally be ascertained with the aid of the inertial sensor system present in an ABS system.

One advantageous refinement of the present invention is characterized in that after the end of the cornering, the speed is increased again, independently of the driver, to the value specified by the driver. This increases the ride comfort for the driver, since he/she does not have to reactivate the cruise control function after the end of the curve.

One advantageous refinement of the present invention is characterized in that the transverse acceleration of the motor vehicle is ascertained, and that in response to the presence of cornering, the speed is reduced so far, that the transverse acceleration does not exceed a predefined limiting value. Consequently, the safety of the driver is increased.

One advantageous refinement of the present invention is characterized in that the limiting value for the transverse acceleration may be specified by the driver. This allows the driver to adjust the limiting value to his/her personal driving style and comfort range.

In a manner analogous to the transverse acceleration, further operating dynamics variables, such as the vehicle deceleration and the vehicle acceleration, may also be limited.

One advantageous refinement of the present invention is characterized in that the speed is reduced in such a manner, that a predefined, limiting deceleration value is not exceeded.

One advantageous refinement of the present invention is characterized in that the limiting value for the acceleration may be specified by the driver.

One advantageous refinement of the present invention is characterized in that the speed is increased in such a manner, that a predefined, limiting acceleration value is not exceeded.

One advantageous refinement of the present invention is characterized in that the limiting value for the acceleration may be specified by the driver.

In addition, the present invention includes an apparatus having devices, which are configured to implement the methods according to the present invention. In this context, it is, in particular, a control unit, in which the program code for implementing the methods of the present invention is stored.

### BRIEF DESCRIPTION OF THE DRAWING

The FIGURE shows the functional sequence of an embodiment of the method according to the present invention.

### DETAILED DESCRIPTION

As explained above, it is believed that a number of motorcycles may be equipped with an anti-lock braking system suitable for cornering. It includes a sensor system, which ascertains the accelerations in all three spatial directions, as well as the rates of rotation about all three spatial directions. The occurrence of cornering may be detected with the aid of these variables. With regard to the operating dynamics variables, motorcycle drivers have a comfort range, within which they feel happy and secure. This comfort range is not fixed, but is a strong function of the experience and the personality of the driver. This comfort range extends to the question of how rapidly a motorcyclist travels through a curve, and how hard he/she brakes during cornering and subsequently accelerates again.

The present invention relates to the interaction of a function for maintaining a constant speed, that is, a cruise control function, with the requirements in the case of cornering. During cornering, it is often necessary to reduce the vehicle speed. However, this is not provided in an activated cruise control function. Therefore, the cruise control function, or at least its portion for maintaining a constant speed, is temporarily deactivated in response to the detection of an existing curve, and then reactivated after the curve is exited. The reduction in the speed necessary for safely coping with the curve takes place in such a manner, that the vehicle deceleration occurring in this instance does not exceed a predefined, limiting deceleration value. The increase in speed following the end of the cornering occurs likewise in such a manner, that a predefined, limiting longitudinal acceleration value is not exceeded. In this context, the limiting deceleration value and the limiting longitudinal acceleration value may, for example, be a function of the ability of the driver or of the existing roadway conditions, as well, such as the condition of its surface or its coefficient of friction. Limiting values may also be specified for the transverse acceleration and longitudinal acceleration occurring during the cornering. It is also possible for these limiting values to be set by the driver.

The functional sequence of an embodiment of the method according to the present invention is shown in the FIGURE. In block 100, the method starts with the activation, by the driver, of a function for maintaining a constant speed, that is, a cruise control function. In block 101, it is subsequently checked if cornering is occurring. If this is not the case, then the method returns to block 100, and the cruise control function continues to keep the speed constant. However, if, in block 101, is it detected, with the aid of sensor signals, that cornering is presently occurring, then, in block 102, the speed is reduced, if necessary, until, e.g., the transverse acceleration has fallen below a predefined limiting value. In block 103, it is subsequently checked if the cornering has ended. If this is not the case, then the method returns to block 102, and the reduced speed is maintained. However, in block 103, if it is revealed that cornering is no longer occurring, then, in block 104, the speed is increased until the speed set within the scope of the cruise control function is reached, and the cruise control function is continued.

What is claimed is:

1. A method for temporarily deactivating a function for maintaining a constant speed for a two-wheeled motor vehicle, independently of a driver, the method comprising:
specifying, by the driver, a speed to be maintained;
detecting an occurrence of cornering; and
reducing, in response to the occurrence of cornering, the specified speed, independently of the driver.

2. The method of claim 1, wherein cornering is detected with a GPS sensor system or with a sensor system of an anti-lock braking system.

3. The method of claim 1, wherein after the end of the cornering, the speed is increased again to the value specified by the driver.

4. The method of claim 1, wherein the transverse acceleration of the motor vehicle is ascertained, and in response to the occurrence of cornering, the speed is reduced so far, that the transverse acceleration does not exceed a predefined limiting value.

5. The method of claim 4, wherein the limiting value for the transverse acceleration is specifiable by the driver.

6. The method of claim 1, wherein the speed is reduced so that a predefined, limiting deceleration value is not exceeded.

7. The method of claim 6, wherein the limiting value for the deceleration is specifiable by the driver.

8. The method of claim 3, wherein the speed is increased so that a predefined, limiting acceleration value is not exceeded.

9. The method of claim 6, wherein the limiting value for the acceleration is specifiable by the driver.

10. An apparatus for temporarily deactivating a function for maintaining a constant speed for a two-wheeled motor vehicle, independently of a driver, comprising:
a device configured to perform the following:
specifying, by the driver, a speed to be maintained;
detecting an occurrence of cornering; and
reducing, in response to the occurrence of cornering, the specified speed, independently of the driver.
